(19) United States
(12) Patent Application Publication
(10) Pub. No.: US 2022/0097004 A1
(43) Pub. Date: Mar. 31, 2022

(54) METHOD AND SYSTEM FOR REMOVING CARBON DIOXIDE FROM AIR

(71) Applicants: Aleksander Makaruk, Wien (AT); Axiom angewandte Prozesstechnik GES.M.B.H, Ebreichsdorf (AT)

(72) Inventors: Aleksander MAKARUK, Wien (AT); Johannes SZIVACZ, Weigelsdorf (AT)

(21) Appl. No.: 17/425,639

(22) PCT Filed: Jan. 24, 2020
(86) PCT No.: PCT/EP2020/051747

§ 371 Date: Jul. 23, 2021

(30) Foreign Application Priority Data
Jan. 24, 2019 (EP) 19153598.8

(51) Int. Cl. B01D 61/42; B01D 61/54; B01D 61/52; B01D 61/48

(52) U.S. Cl. CPC B01D 61/422; B01D 61/54; B01D 2257/504; B01D 61/485; B01D 2258/06; B01D 61/52

(57) ABSTRACT

The invention relates to a method for removing and obtaining carbon dioxide from ambient air, comprising the continuous execution of the following steps: a) bringing ambient air into contact with an aqueous solution of at least one alkali metal or alkaline earth metal for the purpose of absorbing the carbon dioxide into the solution, forming the bicarbonate or carbonate of the at least one metal; b) electrodialysis of the resulting solution using a combination of bipolar ion-exchange membranes and ion-exchange membranes that are selective for mono- and multivalent anions to obtain one solution enriched in (bi-)carbonate anions and one solution depleted in (bi-)carbonate anions, wherein the solution depleted in (bi-)carbonate anions is recycled to step a); c) thermal desorption of the carbon dioxide from the solution, obtained in step b), enriched in (bi-)carbonate anions by means of steam stripping in order to obtain a carbon dioxide-steam mixture and a solution depleted in CO₂ which is recycled to step (b), wherein a pH is set there of between 7 and 8.5 or between 8 and 9.5; and d) removing water from the obtained carbon dioxide-steam mixture by cooling to condense the steam, and possibly further drying of the carbon dioxide.

### STATE OF THE ART

Because of the low CO₂ content of air and the high energy use of separation methods, filtering the global warming gas CO₂ from the atmosphere has been regarded as inefficient and hardly implementable in an industrial scale. Nevertheless, corresponding methods have been developed because the CO₂ obtained thereby does not necessarily have to be stored, but could be used, for example, in the beverage industry, in greenhouses or for chemical syntheses, e.g for producing methane by reaction with hydrogen, which can sometimes be obtained in a sustainable manner by water electrolysis using solar and/or wind electrical energy, or for producing synthetic fuels. For the latter purpose, however, there are to be high requirements regarding the purity of the separated CO₂, and it requires continuous large amounts of pure gas, which results in an enormous increase of production costs.

A modern method for separating carbon dioxide, which is, for example, being used by the Swiss company Climeworks in Switzerland and in Iceland, consists in blowing ambient air via numerous enormous fans over filters, the surface of which is impregnated with amines to which the acidic CO₂ is adsorbed. Subsequent desorption is achieved by heating the “loaded” filter, which requires large amounts of thermal energy. While waste heat of power plants or incinerators can (at least largely) be used therefor, the energy requirements of the method per se remain high. In particular because during desorption via simply heating the filter which is done in the presence of air—a product gas is obtained, which also contains relatively large amounts of N₂ (typically at least 5% by volume) in addition to CO₂, the separation of which is extremely complicated. But also because the absorbent impregnated with amines is relatively instable and has to be replaced from time to time. US 2010/059377 A1 discloses a method for recovering CO₂ from exhaust gases from factories, in particular from plants generating electric power by burning fossil fuels and from coal gasification plants. This includes the absorption of the CO₂ and further components of the exhaust gas into a 10 to 50% aqueous K₂CO₃/KHCO₃ solution in a spray tower, followed by an ion exchange for removing multivalent cations, where-after the solution is pressurized to 2 to 200 atm, preferably to >30 atm. During a subsequent electrodialysis using a bipolar dialysis membrane, part of the hydrogen carbonate ions is removed. During dialysis, these move to a process stream buffered at a constant pH value of 3 to 4, which is the reason for the previous pressurization, in order to inhibit escape of the CO₂ during dialysis. Then, this process stream enriched with CO₂ is simply ventilated, i.e. the pressure is released, so that the CO₂ escapes from the strongly acidic solution.

A primary disadvantage of this method is the strongly acidic pH value of the process stream enriched with CO₂, which on the one hand requires the application of high pressures during dialysis, which increases energy as well as equipment requirements during the execution of the method, and on the other hand leads to a much higher energy requirement for the dialysis, which increases proportionally with the pH difference between the solutions on the concentrate and the diluate sides, which is also described in US 2010/059377 A1. Therefore, this method is suitable for separating CO₂ from gas mixtures containing high concentrations of CO₂, e.g. 10-25% by volume or more in combustion exhaust gases, but not for recovering CO₂ from ambient air, which usually has a CO₂ content of only approximately 400 ppm.

Against this background, it was an object of the present invention to develop a new method and a corresponding facility that allow for recovering from air CO₂ with high purity and with less energy input than before.

### SUMMARY OF THE INVENTION

In a first aspect, the present invention achieves this object by providing a method for separating and recovering carbon dioxide from ambient air, comprising the continuous execution of the following steps:
a) bringing ambient air into contact with an aqueous solution of at least one alkali metal or alkaline earth metal cation for absorbing the carbon dioxide into the solution, forming the bicarbonate or carbonate of the at least one metal;
b) electrodialysis of the resulting solution using a combination of bipolar ion-exchange membranes and ion-exchange membranes that are selective for mono- or multi-valent anions to obtain one solution enriched with (hydrogen) carbonate ions and one solution depleted of (hydrogen) carbonate ions, wherein the solution depleted of (hydrogen) carbonate ions is recycled to step a);
c) thermal desorption of the carbon dioxide from the solution obtained in step b) that is enriched with (hydrogen) carbonate ions by means of steam stripping in order to obtain a carbon dioxide-steam mixture and a solution depleted of CO₂ that is recycled to step (b), whereupon a pH between 7 and 8.5 or between 8 and 9.5 is set therein; and
d) separating water from the obtained carbon dioxide-steam mixture by cooling to condense the steam, and optionally further drying of the carbon dioxide.

This sequence of steps, being individually known per se, allows for recovering CO₂ in high purity and in a relatively energy-efficient manner from air. Due to the enrichment step b) via electrodialysis the volume of the further process stream can be substantially reduced compared to comparable absorption methods according to prior art, which significantly reduces equipment and energy requirements for transport and further treatment. And contrary to the filter according to the state of the art mentioned in the introductory section, which are only superficially provided with amino groups, the present invention, in certain cases, allows for using solutions having high concentrations of alkali or alkaline earth metal cations, which also reduces the volume of the initial process streams and thus the energy consumption.

Also compared to the method disclosed in US 2010/059377 A1, that of the present invention distinguishes itself through much lower energy and equipment requirements, since no pressure has to be applied to any of the two circulated solutions and the dialysis of the (hydrogen) carbonate ions is conducted from a first to a second alkaline solution. The pH difference therebetween is preferably not more than 2, more preferably ably not more than 1, which significantly reduces the energy consumption of the dialysis step compared to the state of the art.

In preferred embodiments of the inventive method, in step a), the water of a natural or artificial lake having a sufficiently high concentration of alkali or alkaline earth metal ions, e.g. a flooded gravel pit or open pit lake, is used as the solution of the at least one alkali or alkaline earth metal cation, wherein a sufficiently high ion concentration is meant to be one resulting in a pH of the water of at least 7.5 and which is optionally pre-set by adding a base. In general, according to the present invention, due to the higher solubility of hydroxides and carbonates, a solution of alkali metal ions is preferred to one of alkaline earth metal ions, more preferably a solution of Na⁺ or K⁺ ions, in particular of Na⁺ ions, due to cost reasons. Such electrolyte systems are stable, i.e. there is no exchange or loss of electrolyte ions with or to the atmosphere. By using additional chemicals such as methanol or formaldehyde the sorption capacity of the absorption solution or the sorption rate may be increased; however, this is not necessary for operating the disclosed system and thus not preferred due to cost and environmental protection reasons.

However, it is preferred according to the present invention that the solution has a pH of at least 8.0 so that the absorbed CO₂ is not present in the form of relatively instable carbonic acid, but completely in the form of hydrogen carbonate or carbonate ions. FIG. 1 shows a graphic representation of the pH-dependent equilibrium between the three species, which will be explained in more detail further below.

By using a natural or artificial standing water, there are enormous amounts of absorption solution available in step a), so that large amounts of CO₂ can be absorbed into the alkaline solution within a relatively short time—and that without having to provide for mixing the solution with the air. According to the present invention, however, the aqueous solution of the at least one alkaline or alkaline earth metal cation is preferably brought into contact with the ambient air by using any device for promoting the absorption of CO₂ gas into the alkaline solution, in order to shorten the period of time necessary for absorbing a certain amount of CO₂ gas and to increase the yield of the inventive method per time unit. hi addition to absorbers and gas scrubbers, e. g. packed or plate columns, jet, dip, vortex, rotation or venturi washers, a spray washer or spray tower is particularly preferred according to the present invention because it can be operated in a very energy-efficient manner.

Due to the good solubility of, for example, the hydroxides of Na or K, the CO₂ sorption capacity of the water can be substantially increased. However, further positive properties of such an electrolyte system based on alkali metals or alkaline earth metals are also its non-toxicity, stability and lowering of the water freezing point, which further increases the sorption capacity into a natural or artificial standing water body at low ambient temperatures.

The electrodialysis in step b) of the inventive method is conducted in an electrodialysis separator, in which a combination of bipolar ion-exchange membranes and ion-exchange membranes selective for mono- or multivalent anions are used because these membranes are able to very efficiently conduct the dialysis of (hydrogen) carbonate ions. In addition, it is to be generally noted that any occurrence of the term “(hydrogen) carbonate ions” as used herein is meant to indicate “hydrogen carbonate and/or carbonate ions”. For the dialysis step, for example, this means that, depending on the desired course of the method, primarily or substantially only monovalent hydrogen carbonate ions or primarily or substantially only bivalent carbonate ions or simultaneously both of them are enriched on the concentrate side of the electrodialysis separator. Which variation is selected depends inter alia on the concentration of the solution of the at least one alkali metal/alkaline earth metal ion as well as on its pH value. In the case of relatively strongly diluted solutions, for example, when natural or artificial standing water bodies are used as the absorption solution in step a), i.e. solutions having a pH between 7.5 and 8.5, the absorbed CO₂ is primarily present as hydrogen carbonate, as can also be seen in FIG. 1.

In addition, absorption, i.e. the phase transition of CO2 from the gaseous to the liquid phase, can be accelerated by setting even higher pH values because the presence of larger base amounts shifts the equilibrium of chemical reactions towards the product sides:

NaOH+CO₂→NaHCO₃

2NaOH+CO₂→Na₂CO₃+H₂O.

As mentioned above, in preferred embodiments of the invention, a pH value of 8 is set for the solution of the at least one alkali metal/alkaline earth metal ions in step a). However, the particularly preferred pH range also depends on whether a natural or artificial standing water body or another type of absorber(s) is used for absorption, e.g. one or more spray washers or spray towers or the like. Especially in natural water bodies a pH between 8 and 9, in particular 8 and 8.5, is particularly preferred according to the invention. At these values, damage to the environment is largely avoided and the dissolved CO₂ is almost exclusively present in the form of HCO₃⁻ ions so that 1 mole of CO₂ can be bound per mole of alkali metal cations, and even 2 moles of CO₂ can be bound per mole of alkaline earth metal cations, which provides for an efficient use of the amount of base present. However, as mentioned above, the absorption process thus takes longer than at pH values of more than 9 or even more than 10. Especially when using absorber devices such as spray washers or the like, a pH of 10 to 11 may absolutely be set.

The type of the carbonate being enriched in the solution, i.e. whether it is primarily a hydrogen carbonate or a carbonate, also determines the choice of the dialysis membranes. When using a standing water boxy as the absorber and setting the pH value between 8 and 9 at the diluate-side solution, which is preferred according to the invention, ion exchanger membranes being selective for monovalent anions are consequently preferably used in step b), and a solution enriched with hydrogen carbonate ions and a solution depleted thereof are obtained during dialysis.

Independently of which ion species are enriched on the concentrate side and depleted on the diluate side in the dialysis step b), the solution depleted of (hydrogen) carbonate ions, preferably hydrogen carbonate ions, obtained thereby is recycled to step a) and thus circulates in the continuous method of the present invention in order to provide for a substantially constant liquid volume in this (first) cycle.

The concentrate-side solution enriched with (hydrogen) carbonate, preferably hydrogen carbonate ions, is subjected to steam stripping in step c), for which any suitable equipment or device may be used, such as falling-film evaporators or other desorbers, herein collectively referred to as “desorption columns”, preferably having a steam supply line discharging into the bottom thereof. In preferred embodiments of the invention, steam stripping is conducted in a packed column and optionally at underpressure due to efficiency reasons, in order to support the phase transition of the carbon dioxide from the liquid into the steam phase. Thereby, a carbon dioxide/water steam mixture as well as a CO₂-depleted solution are obtained.

Contrary to the solution of the at least one alkali metal/alkaline earth metal cation in the absorber, in which, as mentioned above, sometimes high pH values of more than 9 or even more than 10 may be set, it is advantageous for the solution which is obtained as a concentrate in the dialysis step and depleted of (hydrogen) carbonate ions, preferably hydrogen carbonate ions, to set a low pH value in order to promote desorption. As shown in FIG. 1, at a pH value falling below 8, more and more of the absorbed CO₂ is present in the form of carbonic acid, H₂CO₃, which tends to decarboxylate, thus releasing the absorbed CO₂, i.e. desorbing it again. In preferred embodiments of the invention, a pH value of less than 9.5 or less than 8.5, more preferably less than 8 or less than 7.5, is thus set in this concentrate. Theoretically, it is even possible to work in the acidic range at a pH of less than 7. This may, however, lead to pressure problems in the separator and in the conduit from the separator to the desorption column because of premature desorption, so that pressure-resistant conduits would be necessary, which would, however, increase equipment energy requirements of the dialysis and is therefore not considered according to the present invention.

According to the present invention, the solution depleted of CO₂ and subjected to steam stripping in step c) is then recycled to step b) in order to enrich it again with (hydrogen) carbonate ions in the dialysis separator, which again provides a substantially constant liquid volume in this second cycle.

Due to the above reasons, preferably a pH between 7 and 8.5 or, in case of high pH values in the solution circulating in the first cycle, also between 8 and 9.5, more preferably between 7.5 and 8.5, is set in the second cycle in order to suppress desorption before steam stripping and to not interfere with the electrodialysis. To promote the decarboxylation of carbonic acid in the desorption column, the solution enriched with (hydrogen) carbonate ions may be heated and/or a vacuum may applied thereto before or during steam stripping instead of—or in addition to—choosing an acidic pH value, which will be explained in more detail further below.

According to the invention, the separation of water from the carbon dioxide/water mixture obtained in step c) is achieved in step d) by simply cooling the mixture to condensate the water steam, which results in liquid water and more or less still damp carbon dioxide gas, which—depending on the intended use—may be further dried.

In preferred embodiments of the inventive method, the relatively cold solution obtained in step b) and enriched with (hydrogen) carbonate ions is, as mentioned above, heated before steam stripping because higher temperatures also promote the desorption of CO_{2.} This is in particular done by heat exchange with
i) the relatively hot solution that has already been subjected to steam stripping, before it is recycled to step b): and/or
ii) the carbon dioxide/water steam mixture obtained during steam stripping, in order to heat the solution enriched with (hydrogen) carbonate ions before steam stripping and at the same time cooling the solution depleted of (hydrogen) carbonate ions through steam stripping and/or cooling the carbon dioxide/water steam mixture for condensating the water steam in step d).

In this way, a large part of the thermal energy used in the method is recycled just like the liquid streams, which substantially increases energy efficiency. This may further increased in preferred embodiments by recycling also the condensate obtained by cooling the carbon dioxide/water steam mixture to step b) and/or to step c), in order to again produce water steam for steam stripping therefrom.

In preferred embodiments, the inventive method is particularly energy efficient and environmentally friendly by
i) using waste heat of a power plant or factory for producing the water steam in step c) and/or for heating the solution obtained in step b) and enriched with (hydrogen) carbonate ions before steam stripping in step c); and/or
ii) using DC from renewable energy sources for electrodialysis.

In a second aspect, the present invention also provides a facility or system (herein in the following used synonymously) for continuously conducting a method for separating and recovering carbon dioxide from ambient air according to the first aspect of the invention, wherein this facility comprises the following devices or facility sections in fluid communication with one another via corresponding connecting conduits:
a) an absorber or a standing water body (herein in the following also comprised in the term “absorber”, as long as the context does not dictate otherwise) for bringing ambient air into contact with an aqueous solution of at least one alkali metal or alkaline earth metal cation for absorbing the carbon dioxide into the solution by forming the hydrogen carbonate or carbonate of the at least one metal;
b) an electrodialysis separator comprising a combination of bipolar ion exchanger membranes and ion exchanger membranes selective for mono- or multivalent anions for conducting ion exchange to obtain one solution enriched with (hydrogen) carbonate ions and one depleted thereof, as well as a conduit for recycling the solution depleted of (hydrogen) carbonate ions to a);
c) a desorption column for conducting steam stripping of the solution enriched with (hydrogen) carbonate ions to obtain a carbon dioxide/water steam mixture and a solution depleted of CO₂, as well as a conduit for recycling the solution depleted of CO₂ to b) and means for setting a pH value of between 7 and 8.5 or between 8 and 9.5 therein; and
d) a condenser for separating water from the obtained carbon dioxide/water steam mixture through condensation, and optionally a drier for the carbon dioxide.

By means of such a facility, the method according to the first aspect of the present invention may be efficiently conducted, wherein according to the invention any of the devices mentioned under a) to d) above, i.e. the absorber, the separator, the desorption column, and the condenser, depending on the respective method implementation multiple units thereof—connected in series or parallel—may be provided. This means that the terms “an absorber” and “the absorber” may also be interpreted as “at least one absorber” or “the at least one absorber”, and the same is true for the separator, the desorption column, and the condenser, which will be explained in further detail in the examples below.

According to the preferred embodiment of the method described above, the inventive facility for obtaining the advantages described above is preferably characterized by one or more—in particular all—of the following eight features:
1) the absorber is a spray washer or spray tower;
2) the electrodialysis separator is provided with bipolar ion exchanger membranes and with ion exchanger membranes selective for monovalent anions in order to only let hydrogen carbonate ions pass through to the concentrate side;
3) the desorption column is a packed column;
4) the desorption column is connected to an evaporator for introducing water steam;
5) the desorption column is connected to a vacuum pump for producing underpressure therein;
6) the desorption column and the electrolysis separator are connected via a conduit for recycling the solution subjected to steam stripping;
7) a heating device for heating the solution enriched with (hydrogen) carbonate ions before steam stripping is provided between the electrolysis separator and the desorption column, wherein the heating device is preferably a heat exchanger in order to, before steam stripping, subject the relative cold solution enriched with (hydrogen) carbonate ions in the electrodialysis separator to a heat exchange with
   i) the relatively hot solution that has already been subjected to steam striping before recycling it to the electrodialysis separator in order to heating the former solution and cooling the latter solution; and/or
   ii) the carbon dioxide/water steam mixture obtained during steam stripping, in order to heat it and cool the carbon dioxide/water steam mixture to condensate the water steam;
8) the condenser for recycling the condensate obtained during cooling of the carbon dioxide/water steam mixture is
   i) connected to the electrodialysis separator via a conduit; and/or
   ii) connected to the evaporator via a conduit to again produce water steam from the condensate.

Further increases of energy efficiency and environmental compatibility of the inventive facility may be achieved by—as has also been already explained regarding the implementation of the method—connecting the facility
i) to a power plant or factory via corresponding pipe conduits in order to utilize their waste heat for producing the water steam in step c) and/or for heating the solution obtained in step b) and enriched with (hydrogen) carbonate ions before steam stripping in step c); and/or
ii) to a renewable energy source via a power line to use the DC produced there in an environmentally friendly way for the electrodialysis in step b).

### SHORT DESCRIPTION OF THE DRAWINGS

The present invention will now be described in more detail with reference to preferred embodiments that are, of course, only provided for illustrative purposes and are not meant to limit the invention, a calculation example for the energy consumption of the inventive method and the associated facility, as well as with reference to the enclosed drawings, wherein;

FIG. 1 is a graph showing the pH-dependent equilibrium between carbonic acid, hydrogen carbonate, and carbonate in aqueous solutions.

FIG. 2 is a flow diagram of a particularly preferred embodiment of the inventive method or the inventive facility.

FIG. 3 is a schematic representation of a preferred arrangement of anion-selective (“A”) and bipolar (“AK”) membranes in an electrodialysis separator in step b) of the method.

### EXAMPLES

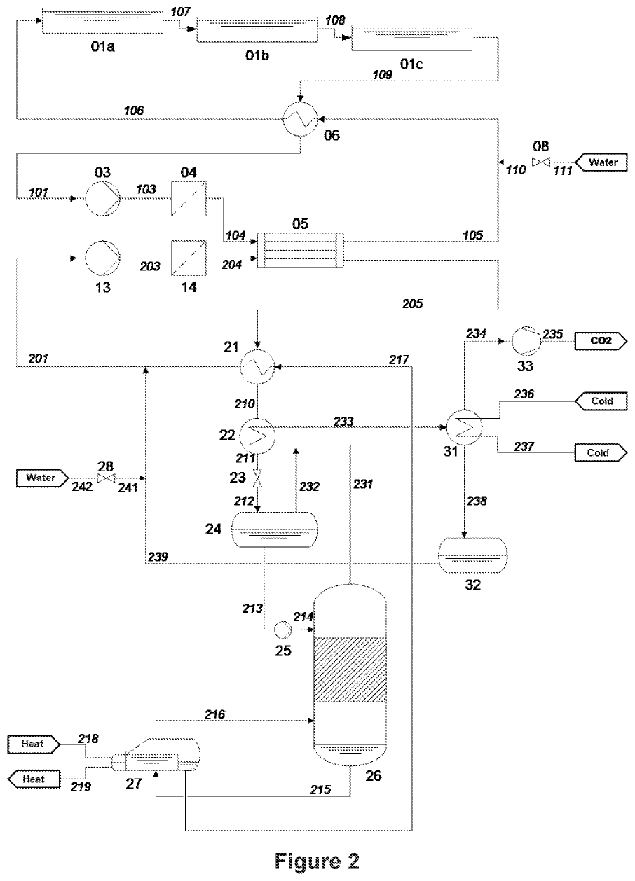

Preferred embodiments for implementing the inventive method or the inventive facility may be designed as schematically shown in FIG. 2. The reference numbers therein have the following meaning, wherein three-digit reference numbers for conduits also refer to the fluid steams transported therein.

### Key to FIG. 2:

01a absorber/lake
01b absorber/lake
01c absorber/lake
06 heat exchanger diluate-inlet diluate-outlet (“economizer”)
08 valve—freshwater for diluate
03 recirculation pump diluate
04 filtration/conditioning diluate
05 electrodialysis
13 recirculation pump concentrate
14 filtration/conditioning concentrate
21 heat exchanger concentrate-inlet/concentrate-outlet (“economizer”)
22 heat exchanger concentrate-outlet/CO₂ wet (“economizer”)
23 expansion valve
24 expansion container
25 sprinkling pump
26 regeneration column/desorption column
27 evaporator
28 valve—freshwater for concentrate
31 condenser/drier
32 condensate container
33 vacuum pump
101 diluate, heated
103 diluate under increased pressure
104 diluate, conditioned/filtered
105 diluate, recycled for absorption, warm
106 diluate, recycled for absorption, cold
107 connection absorber
108 connection absorber
109 diluate, cold
201 concentrate, cold
203 concentrate with increased pressure
204 concentrate, conditioned/filtered
205 concentrated, recycled for desorption, cold
210 concentrate, heated
211 concentrate, heated
212 concentrate, expanded
213 concentrate after expansion in expansion container
214 concentrate, sprayed
215 concentrate supply to evaporator
216 steam/CO₂ mixture for regeneration
217 concentrate, regenerated
231 CO₂, wet, warm
233 CO₂, wet, cold
234 CO₂, dried
235 CO₂, dried, no underpressure
238 condensate
239 condensate feedback to concentrate
218 heat supply to evaporator
219 heat supply to evaporator
241-242 freshwater for concentrate
236-237 cold for cold drying
110-111 freshwater for diluate

The inventive method and the inventive facility start, as shown at the top of FIG. 2, with several absorbers 01a-c serially connected via conduits 107 and 108 for absorbing CO₂ from ambient air, which in preferred embodiments are either natural or artificial water bodies such as lakes or quarry ponds, or spray washers or spray towers, or a combination thereof. In the case of several absorbers, the solutions contained therein of at least one alkali metal or alkaline earth metal cation may be set to different pH values by, for example, containing different concentrations of at least one alkali metal or alkaline earth metal cation or by setting the respective pH values in a different manner, e.g. by separate addition of acids or bases.

In particular, the cations are—due to better solubility of hydroxides and carbonates compared to alkaline earth metal ions—alkali metal cations, more preferably Na⁺ or K⁺ ions or a mixture thereof. In the calculation example below, K⁺ ions are used. Furthermore, the solution may contain additives in the absorbers to increase the sorption capacity of the absorption solution or the sorption rate, such as low alcohols or formaldehyde: however, these are not required for operation of the invention and not preferred due to environmental and cost reasons.

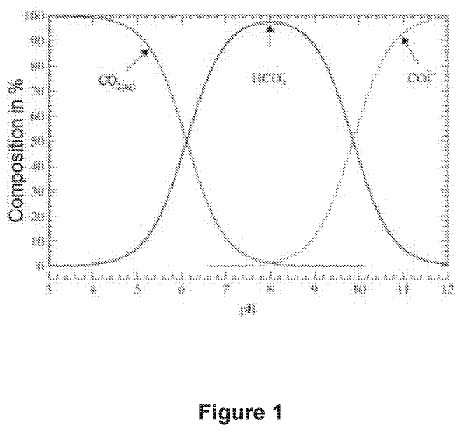

In the alkaline solution, CO₂ is absorbed from ambient air—either due to spontaneous absorption without external interference or through accelerated absorption, e.g. in a spray tower—depending on the pH value of the solution to form hydrogen carbonate and/or carbonate anions. Preferably, a pH between 7.5 and 8.5 is set when using one or more standing water bodies, at which pH the absorbed CO₂ is primarily present as hydrogen carbonate, which may be seen in the graphic representation of the equilibrium between carbonic acid, hydrogen carbonate and carbonate in FIG. 1. A higher pH value might lead to environmental damages. If, on the other hand, absorption devices such as spray washers or towers are used, a substantially higher pH may be preferably set, e.g. a pH value between 10 and 11, to promote absorption.

The alkaline solution of the absorbed CO₂ is then subjected to a dialysis step and for this purpose supplied to a electrodialysis separator 05. This may either be done directly or, as shown in FIG. 2, preferably after heating and/or filtering or conditioning the solution. On the one hand, heating increases the mass transfer during the dialysis process, and on the other hand the heat of a liquid stream arising later in the method, but being recycled to a previous step, which would otherwise be lost as waste heat, may be used for this purpose. Consequently, optional heating is preferably conducted by means of a heat exchanger 06, to which the alkaline solution of the absorbed CO₂ is supplied via a conduit 109, and in particular heat exchange is conducted with the solution depleted of (hydrogen) carbonate ions during dialysis, before they are recycled to the absorption step. Optional filtration may largely remove contaminants, as they may occur especially when using standing waters as absorbers, from the solution before dialysis, and conditioning herein refers to the optional addition of pH regulators and/or other additives for promoting the absorption and desorption processes. In preferred embodiments, filtration and conditioning are conducted substantially simultaneously in a filter/conditioner 04 to which the alkaline solution of the absorbed CO₂ is supplied in FIG. 2 via conduit 101, pump 03 and conduit 103.

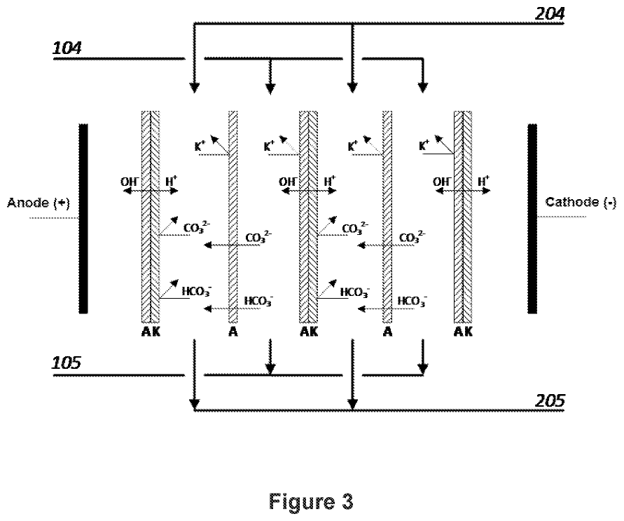

From there, the heated and filtered/conditioned solution reaches, via a conduit 104, the electrodialysis separator 05, where one solution depleted of (hydrogen) carbonate ions and one enriched therewith are obtained. Regarding the preferred choice of a pH value of the alkaline solution in the absorption step between 10 and 11 according to the invention—in the case of using spray washers as absorbers—a combination of anion-selective ion exchanger membranes “A” and bipolar membranes “AK” is used in the electrodialysis separator 05 in order to conduct dialysis as shown in FIG. 3. If, on the other hand, for example a pH of the absorption solution of only between 7.5 and 8.5 is set in a standing water as absorber, at which the absorbed CO₂ is primarily present as hydrogen carbonates and only at a very low extent as carbonates, ion exchanger membranes selective only for monovalent anions are preferably used instead of the anion-selective membranes “A” in order to selectively enrich or deplete only hydrogen carbonate on the dilate side or concentrate side, respectively.

The concentrate thus obtained in the separator 05 is passed to the next step, steam stripping, via a conduit 205, while the diluate depleted of CO₂, which is usually heated during dialysis through the warm solution preferably recycled from steam stripping, is in preferred embodiments recycled via conduit 105 to the heat exchanger 06, where it releases its heat to the alkaline solution of the absorbed CO₂ before it reaches the dialysis step, and subsequently recycled back via conduit 106 to the absorbers 01a to 01c. In order to balance any water loss in this absorber solution cycle, preferably a water supply conduit is provided consisting of conduits 110 and 11l with a valve 08 therebetween.

Forwarding the solution enriched with (hydrogen) carbonate ions in the electrodialysis separator for steam stripping via conduit 205 may again be done directly or in preferred embodiments of the present invention subjected to various operations before, particularly preferred to a heat exchange, in particular with one or more process steams arising from steam stripping, in order to heat them before they enter the desorption column 26 and thus increase desorption. In addition, the solution being subject to overpressure during pumping may also be subjected to an expansion step for the same purpose.

A combination of both measures is shown in FIG. 2: via conduit 205, the enriched solution first passes from electrodialysis separator 05 to a heat exchanger 21, where it is subjected to heat exchange with the alkaline solution recycled from steam stripping via conduit 217, and then it is supplied via conduit 210 to a further heat exchanger 22, where it is subjected to heat exchange with a hot gas mixture of water steam and carbon dioxide obtained during steam stripping, which is supplied to heat exchanger 22 via conduit 231. Then, the thus heated solution is supplied via conduits 211 and 212 and valve 23 to an expansion container 24 in order to expand them. Any CO₂ already desorbed during this expansion is led from expansion container 24 via conduit 232 to conduit 231 and thus into the CO₂/H₂O gas mixture supplied to heat exchanger 22. The expanded solution is then, via conduit 213 and 214 and sprinkling pump 25, fed into desorption column 26 in order to subjected to steam stripping there.

Preferably, an evaporator 27 is connected to the desorption column 26, which evaporator generates the water steam required for steam stripping, which steam is fed into the column via conduit 216. Here, the evaporator is preferably operated with waste heat from a power or incineration plant, as is partly shown in FIG. 2 via conduits 218 and 219. Alternatively or in addition, heat of the hot gas mixture of CO₂ and water steam contained in the desorption column may be fed via a heat exchanger to evaporator 27.

In the desorption column 26, which preferably is a packed column, as indicated in FIG. 2 by hatching, the preheated solution enriched with (hydrogen) carbonate ions is led as a countercurrent to ascending hot water steam, which leads to a decarboxylation and desorption of the CO₂ dissolved as (hydrogen) carbonate and to the formation of the mentioned hot gas mixture of carbon dioxide and water steam, which exits the column via conduit 231. In addition, the pH in the (hydrogen) carbonate solution may be lowered for supporting desorption, for example by introducing gaseous or aqueous HCI, which is, however, not preferred due to cost and environmental reasons.

The alkaline solution depleted of CO₂ may now be discarded; preferably, however, it is recycled, either directly—or after previous heat exchange with the solution to be desorbed in heat exchanger 21—to the dialysis step or first again to the desorption column 26, in order to complete desorption, before it is recycled to the electrodialysis separator 05. The latter variation is shown in FIG. 2: the solution subjected to desorption is fed via conduit 215 to evaporator 27, where it is used for producing water steam for steam stripping, wherein CO₂ still dissolved at this time is simultaneously desorbed, so that a hot gaseous mixture of CO₂ and H₂O—even though with a relatively lower content of CO₂ than in the column—is formed already here, which is fed into the desorption column 26 as “water steam” as mentioned above and subjected to another desorption, which herein is called “regeneration”. At the same time, however, part of the solution is continuously withdrawn from the evaporator 27 and via conduit 217 to separator 05, wherein this part of the solution subjected to desorption several times is called “regenerate”.

On the way back to electrodialysis, the recycled solution 217 is, as mentioned, subjected, in heat exchanger 21, to a heat exchange with the solution 205 from the dialysis step that still has to be subjected to steam stripping, in order to heat the latter before steam stripping. From there, it reaches, via conduit 201 and 203 and pump 13, preferably also, i.e. like the diluate-side cycled solution, a filter/conditioner 14 in order to remove contaminants before dialysis and optionally set the pH value, and from there via conduit 205 the electrodialysis separator 05. Optionally, the water amount of the so circulated solution may be supplemented by a water supply (not shown). Preferably, in the inventive method, however this supplement is added in a further recycled material, namely the water steam that is drained from the column 26 together with the desorbed CO₂ as a gas mixture. In preferred embodiments it is, as mentioned above, fed via conduit 231 to a heat exchanger 22, where it gives part of the heat to the solution that was enriched with (hydrogen) carbonate ions in the dialysis step and still has to be subjected to steam stripping, whereafter it is fed to a cooler 31 in order to condense off the water from the mixture and thus obtain CO₂ largely freed from water. The latter is drawn from the method via conduits 234 and 235 as well as pump 33, wherein—depending on the intended purpose—it may be subjected to further drying.

The cooler 31 may, for example, be operated with the cold water of a natural flowing water (or also standing water). The condensed water arising and being collected in the condensate container 32 is, according to the present invention, preferably fed back via conduit 239 into the recycled material 201 drawn from the heat exchanger 21 on its way back to dialysis and thus recycled, wherein here the additional water supply is preferably provided via conduits 241 and 232 as well as valve 28 in order to keep the solution volume constant.

Trough these process steps under circulation of water in two cycles on the dilate or condensate side, respectively, of the electrodialysis separator, the method of the present invention may be executed in a highly efficient manner, which will be clearly shown in the calculation example below. However, it is to be understood that the method described in detail above and the associated facility of the present invention may also be put into practice with numerous variations, as long as they are within the scope defined by the attached claims.

For example, the electrodialysis separator 05 may, depending on the technical layout, be provided with various conventional side aggregates, e. g. internal recirculation pumps for intensifying the ion transport, and/or anti-fouling systems (e.g. by alternating electrical polarity). Since during longer operation of the facility, membrane defects in the separator may lead to the enrichment of metal ions in one of the cycles, electro-dialysis may additionally be conducted by using additional pumps for periodically or continuously balancing the metal ions in the diluate or in the concentrate. Nevertheless, all embodiments of the inventive method and the inventive facility comprise two liquid cycles.

### Calculation Example

In this example, a model of the inventive method and the inventive facility as shown in FIG. 2 was calculated based on empirical data and with computer assistance in order to be able to estimate the required energy consumption.

The model is based on the following assumptions:
It is winter and the ambient temperature is 10° C. Since the solubility of gases in liquids increases with decreasing temperatures, the inventive method can absolutely be used at very low temperatures outdoors.
The absorber is a large, artificial basin from which an aqueous (hydrogen) carbonate solution is withdrawn at three places, 01a to 01c.
The alkaline absorption solution is a commercially available 20% caustic potash solution (% by weight), such as those used as electrolyte solutions, having a pH of approximately 10.5.
The pH value is only set in the absorption basin and regulates itself during the further course of the method by the equilibrium setting depending on the CO₂ partial pressure of the ambient air.
The heat required for producing steam is provided in the form of electrical energy.
The desorption takes place at an underpressure of 460 mbara (mbar absolute pressure).
The cooling required for operating the condenser 31 is provided through electrical energy.

All further assumptions and selected or (automatically) set parameters are shown in Table 1 below.

TABLE 1

| Description | Ref. No. | Parameter | Unit | Nominal value | Range | Comment |
|---|---|---|---|---|---|---|
| Atmosphere | 01a. . . 01c | CO₂ content | vol. ppm | 450 | 190 to 1000 | invention also practicable |
| | | temperature | ° C. | +10 | −30 to +40 | below freezing |
| Diluate inlet | 109 . . . 104 | salt content solution | % by weight | ~20 | 1 to 40 | |
| after | | concentration HCO₃⁻ | mol/l | 0.44 | 0.04 to 0.9 | |
| absorption of | | concentration CO₃²⁻ | mol/l | 1.5 | 0.15 to 3.0 | |
| CO₂ | | temperature solution at 104 | ° C. | 17 | 5 to 40 | |
| | | pH value solution | — | 10.4 | 8 to 11.5 | |
| Diluate outlet | 105. . . 106 | concentration HCO₃⁻ | mol/l | ~0 | 0 to 0.1 | |
| | | concentration CO₃²⁻ | mol/l | 1.72 | 0.17 to 5.5 | |
| Electrodialysis | 05 | depletion of HCO₃− in the diluate | mol/l | 0.22 | 0.02 to 0.5 | for membranes selective |
| | | depletion of CO₃²⁻ in the diluate | mol/l | ~0 | ~0 to 0.5 | for monovalent anions |
| | | transition of CO₂ from diluate to | Nm³ CO₂/ m³ | 4.9 | 0.4 to 12 | relative to 1 m³ diluate |
| | | concentrate | | | | stream |
| | | energy consumption | kWh/Nm³ CO₂ | 3.5 | 2.4 to 6.0 | |
| Concentrate | 205. . . 214 | salt content solution | % by weight | ~20 | 10 to 40 | |
| outlet | | concentration HCO₃⁻ | mol/l | 3.0 | 1.7 to 6.1 | |
| | | concentration CO₃²⁻ | mol/l | 0.21 | 0.05 to 1.2 | |
| | | relation volume streams | — | 0.3 | 0.1 to 1.2 | usually <0.4 |
| | | concentrate/diluate | | | | |
| | | temperature concentrate at 205 | ° C. | 19 | 15 to 40 | |
| | | temperature concentrate at 210 | ° C. | 73 | 60 to 125 | |
| | | temperature concentrate at 211 | ° C. | 76 | 60 to 125 | |
| | | pH value concentrate | — | 8.5 | 8 to 9.5 | |
| Desorption/ | 26, 27 | column temperature | ° C. | 80 | 70 to 130 | |
| regeneration | | column pressure | mbara | 470 | 300 to 1500 | |
| | | produced steam amount | kg/Nm³ CO₂ | 1.6 | 1.2 to 3.8 | |
| | | heat requirement | kWh/Nm³ CO₂ | 1 | 0.8 to 2.1 | |
| Gas mixture | 231. . . 233 | CO₂ portion in mixture | % by volume | 34 | 12 to 59 | |
| H₂O/CO₂ | | | | | | |
| Concentrate | 201. . . 204 | concentration HCO₃⁻ | mol/l | 1.74 | 0.93 to 2.6 | |
| inlet | | concentration CO₃²⁻ | mol/l | 0.85 | 0.35 to 2.1 | |
| | | temperature at 204 | ° C. | 22 | | |
| Condenser, | 31, 234 | gas mixture after cooling | | | | |
| gas mixture | | temperature | ° C. | 4 | 2 to 8 | |
| H₂O/CO₂ | | CO₂ portion in mixture | % by volume | 96 | 85 to 99 | |
| | | energy consumption cooling | kWh/NM³ CO₂ | 0.22 | 0.15 to 0.4 | |
| Heat recovery | 21, 22 | specific heat loss total | kWh/Nm³ CO₂ | 0.41 | 0.27 to 0.9 | |
| Underpressure | 33 | pressure suction side | mbara | 460 | 300 to 1000 | |
| generation | | pressure pressure side | mbara | 1100 | 950 to 1500 | |
| | | energy consumption | kWh/Nm³ CO₂ | 0.08 | 0.05 to 0.1 | |
| Total energy | | electrical energy | kWh/Nm³ CO₂ | 3.8 | 2.6 to 6.5 | |
| requirement | | heat energy | kWh/Nm³ CO₂ | 1.41 | 1.07 to 3.0 | |

From the table it can be seen that per standard cubic meter CO₂ that is absorbed from the atmosphere and recovered as a 96% pure gas (rest: H₂O) at position 235 in FIG. 2, only relatively low amounts of electrical energy of 3.8 kWh and of heat energy of 1.41 kWh are required.

In addition, the heat energy required for steam production in evaporator 27 could, as mentioned above, be obtained from waste heat of a power plant (or factory) close to the inventive facility and the energy required for cooling in the condenser 31 could at least partly be provided by using the already relatively cold water of a nearby river or lake, which would further reduce the costs for recovering CO₂.

The present invention thus provides an extraordinarily efficient and economic method and an associated facility by means of which carbon dioxide can be recovered from air continuously and in comparably high purity.

1. A method for separating and recovering carbon dioxide from ambient air, comprising the continuous execution of the following steps:
a) bringing ambient air into contact with an aqueous solution of at least one alkali metal or alkaline earth metal cation for absorbing the carbon dioxide into the solution, thus forming the bicarbonate or carbonate of the at least one metal;
b) electrodialysis of the resulting solution using a combination of bipolar ion-exchange membranes and ion-exchange membranes that are selective for mono- or multivalent anions to obtain one solution enriched with (hydrogen) carbonate ions and one solution depleted of (hydrogen) carbonate ions, wherein the solution depleted of (hydrogen) carbonate ions is recycled to step a);
c) thermal desorption of the carbon dioxide from the solution obtained in step b) that is enriched with (hydrogen) carbonate ions by means of steam stripping in order to obtain a carbon dioxide-steam mixture and a solution depleted of CO₂ that is recycled to step (b), wherein a pH between 7 and 8.5 or between 8 and 9.5 is set; and
d) separating water from the obtained carbon dioxide-steam mixture by cooling to condense the steam, and optionally further drying of the carbon dioxide.

2. The method of claim 1, characterized in that, in step a), the water of a natural or artificial lake having a sufficiently high concentration of alkali metal or alkaline earth metal ions, e.g. a flooded gravel pit or open pit lake, is used as said solution of the at least one alkali metal or alkaline earth metal cation, wherein the ion concentration is sufficient to result in a pH of the water of at least 7.5 and is optionally preset by the addition of a base.

3. The method of claim 1, characterized in that, in step a), the aqueous solution of the at least one alkali metal or alkaline earth metal cation is brought into contact with ambient air in a spray washer or spray tower.

4. The method of claim 1, characterized in that, in step b), membranes selective for monovalent anions are used in combination with the bipolar ion exchanger membranes and one solution enriched with hydrogen carbonate ions and one solution depleted thereof are obtained.

5. The method of claim 1, characterized in that steam stripping in step c) is conducted in a packed column, optionally at underpressure.

6. The method of claim to 5, characterized in that the relatively cold solution obtained in step b) and enriched with (hydrogen) carbonate ions is, before steam stripping, subjected to a heat exchange with
i) the relatively hot solution that has already been subjected to steam stripping, before it is recycled to step b), in order to heat the former solution and to cool the latter solution; and/or
ii) the carbon dioxide/water steam mixture obtained during steam stripping, in order to heat it and to cool the carbon dioxide/water steam mixture to condensate the water steam.

7. The method of claim 1, characterized in that the condensate obtained during cooling of the carbon dioxide/water steam mixture is recycled to step b) and/or recycled to step d) in order to again produce water steam for steam stripping therefrom.

8. The method of claim 1, characterized in that
i) waste heat of a power plant or factory is used for producing the water steam in step c) and/or for heating the solution obtained in step b) and enriched with (hydrogen) carbonate ions before steam stripping in step c); and/or
ii) DC from renewable energy sources is used for electrodialysis.

9. A facility for continuously executing the method for separating and recovering carbon dioxide from ambient air according to claim 1, comprising the following devices or facility sections in fluid communication with one another via corresponding connecting conduits:
a) an absorber or a standing water body for bringing ambient air into contact with an aqueous solution of at least one alkali metal or alkaline earth metal cation for absorbing the carbon dioxide into the solution by forming the hydrogen carbonate or carbonate of the at least one metal;
b) an electrodialysis separator comprising a combination of bipolar ion exchanger membranes and ion exchanger membranes selective for mono- or multivalent anions for conducting ion exchange to obtain one solution enriched with (hydrogen) carbonate ions and one depleted thereof, as well as a conduit for recycling the solution depleted of (hydrogen) carbonate ions to a);
c) a desorption column for conducting steam stripping of the solution enriched with (hydrogen) carbonate ions to obtain a carbon dioxide/water steam mixture and a solution depleted of CO₂, as well as a conduit for recycling the solution depleted of CO₂ to b) and means for setting a pH value of between 7 and 8.5 or between 8 and 9.5 therein; and
d) a condenser for separating water from the obtained carbon dioxide/water steam mixture through condensation, and optionally a drier for the carbon dioxide.

10. The facility of claim 9, characterized in that the absorber is a spray washer.

11. The facility of claim 9, characterized in that a heating device for heating the solution enriched with (hydrogen) carbonate ions before steam stripping is provided between the electrodialysis separator and the desorption column.

12. The facility of claim 9, characterized in that the desorption column is connected to an evaporator for introducing water steam and/or connected to a vacuum pump for producing underpressure therein.

13. The facility of claim 9, characterized in that the heating device is a heat exchanger to subject the relatively cold solution enriched with (hydrogen) carbonate ions in the electrodialysis separator to a heat exchange with
i) the relatively hot solution that has already been subjected to steam stripping before recycling it to the electrodialysis separator in order to heat the former solution and to cool the latter solution; and/or
ii) the carbon dioxide/water steam mixture obtained during steam stripping, in order to heat it and to cool the carbon dioxide/water steam mixture to condensate the water steam.

14. The facility of claim 9, characterized in that the condenser for recycling the condensate obtained during cooling of the carbon dioxide/water steam mixture is connected
i) to the electrodialysis separator via a conduit; and/or
ii) to the evaporator via a conduit to again produce water steam from the condensate.
